(19) United States
(12) Patent Application Publication
(10) Pub. No.: US 2025/0005691 A1
(43) Pub. Date: Jan. 2, 2025

(54) EXECUTING AN ACTION USING EXTRACTED INFORMATION FROM A DOCUMENT

(71) Applicant: Adobe Inc., San Jose, CA (US)

(72) Inventors: Nedim LIPKA, Walnut, CA (US); Ryan ROSSI, San Jose, CA (US); Jianna Audrey Reyes SO, Palo Alto, CA (US); Franck DERNONCOURT, Seattle, WA (US); Alexa SIU, Sunnyvale, CA (US)

(21) Appl. No.: 18/344,203

(22) Filed: Jun. 29, 2023

(51) Int. Cl. G06Q 50/18

(52) U.S. Cl. CPC G06Q 50/18

(57) ABSTRACT

A method includes extracting an action from a document using a machine learning model. The action is associated with an action parameter. The method further includes extracting a plurality of action events corresponding to the action from the document using the machine learning model. The method further includes generating a record associated with the document based on the extracted action. The method further includes populating the record with the action parameter. The method further includes executing an action event in the plurality of action events using the record.

### BACKGROUND

An agreement between two parties may involve performing an act (or restraining from performing an act) at some point in time. Generally, to satisfy the agreement, one or more parties involved in the agreement performs one or more steps (or refrains from performing one or more steps). Agreements can be written down (or otherwise documented) to maintain a record of the agreement. As a result, documents associated with the agreement, are produced. The documented agreement can include general terms (e.g., location, party information, effective dates), terms of service (e.g., the party providing the service, the type of service, the delivery mode), compensation (e.g., a condition of when compensation should be paid, a mode of compensation, an amount, due dates), and other clauses such as indemnification, confidentiality, etc. The document agreement defines each party's powers, privileges, immunities, and the like. Understanding and keeping track of each party's right and obligations under the agreement can be complicated. Moreover, maintaining several agreements can become complicated if different agreements involve performing different actions at different dates in time.

### SUMMARY

Introduced herein are techniques/technologies that create a centralized action center. The centralized action center uses information extracted from a document to perform an action (e.g., an obligation). It should be appreciated that while the present disclosure describes executing and tracking actions, action events, which are steps associated with performing the action, are also tracked and executed. The centralized action center also dynamically displays extracted information across multiple documents, including actions to be performed by a party of an agreement, conditions for performing the action, and the like. The centralized action system allows users to prioritize, sort, and navigate such extracted information to increase user comprehension of a document (such as an agreement).

More specifically, in one or more embodiments, the centralized action system extracts information from a document such as actions to be performed, details regarding the performance of the actions, information associated with initiating the action, the steps associated with performing the action, and contextual information. The extracted information is synthesized using various modules. Subsequently, the centralized action system executes the action (or a step of the action), responsive to determining that a step of the action should be initiated. As described herein, executing the action includes performing an obligation on behalf of a user. For example, using the synthesized information, the centralized action system creates invoices, receipts, makes payments, sends emails, generates calendar reminders, and the like. The centralized action system can provide user notifications when the centralized action system has completed the action, when a record (such as an invoice, receipt, draft email), has been generated, and the like. The centralized action system can also display a user-friendly document, indicating portions of the document that were used to extract information. Lastly, the centralized action system can display a summary of previous actions (and a status of completing the action) associated with previously processed documents.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of actionizing information extracted from a document, in accordance with one or more embodiments;

FIG. 2 illustrates example modules executed by the action manager to synthesize extracted information, in accordance with one or more embodiments;

FIG. 3 illustrates an example workflow and the corresponding action events and action parameters associated with the workflow, in accordance with one or more embodiments;

FIG. 4 illustrates an example of the centralized action system visualizing extracted information from a document, in accordance with one or more embodiments;

FIG. 5 illustrates examples of interacting with extracted information using the centralized action system, in accordance with one or more embodiments;

FIG. 6 illustrates an example visualization of extracted information using an action tracker, in accordance with one or more embodiments;

FIG. 7 illustrates an alternate visualization of an action tracker displayed on a dashboard, in accordance with one or more embodiments;

FIG. 8 illustrates a schematic diagram of the centralized action system in accordance with one or more embodiments;

FIG. 9 illustrates a flowchart of a series of acts in a method of actionizing information extracted from a document in accordance with one or more embodiments; and

FIG. 10 illustrates a block diagram of an exemplary computing device in accordance with one or more embodiments.

### DETAILED DESCRIPTION

One or more embodiments of the present disclosure include a centralized action system that executes an action using extracted agreement information. Conventional approaches for increasing a user's understanding of a document summarize information in a document and/or highlight actions to be performed by a user. Other conventional approaches for increasing a user's understanding of the document involve the user manually extracting information from a document and creating a secondary “working document” that is helpful to the user (e.g., user notes). In some cases, after a user has created a “working document,” the user creates a “secondary document” that may be related to the performance of the obligation. For example, “secondary documents” may be formal documents associated with the agreement such as invoices, receipts, and the like. Increasing the user's understanding of the document using summaries, working documents, and/or secondary documents is thought to increase a likelihood of the user successfully performing actions detailed in the document. However, such approaches do not execute actions using extracted information. For example, such approaches do not perform actions on behalf of a user. Moreover, such approaches are static, non-scalable, or overly manual methods.

To address these and other deficiencies in conventional systems, the centralized action system of the present disclosure extracts information from a document and identifies actions (e.g., an obligation of a party) and triggers (e.g., a condition for taking an action). Obligations across various documented agreements may be similar. For example, different documents may both describe payment parameters, termination conditions, and the like. The centralized action system leverages common information and patterns across documents and provides an automated mechanism of tracking and managing such common information. The centralized action system then uses the common information to prepare emails, generate calendar reminders, create and send invoices, create receipts, and the like. As a result, the need for the user's working documents and/or secondary documents reduces, conserving memory of a computing resource. The centralized action system also reduces the repetitive labor of the user manually extracting similar information from documents (or extracting similar information from summaries of documents) and executes an action on behalf of the user. By automating the performance of such actions, the centralized action center conserves computing resources (such as power and memory) involved with a user performing multiple similar actions multiple times. For example, the user does not have to send an email and create an invoice, where the information of the email and the invoice include common information.

Additionally, a user experience is improved as the automatically executed actions performed by the centralized action system reduce risks associated with the success of the agreement. In an example, a user may be exposed to risks associated with missed payments, resulting in fees or a breach of the agreement. By reducing the human error associated with executing actions of a document, the centralized action system reduces the likelihood of inadvertently jeopardizing the agreement and/or incurring unnecessary fees. As a result, computing resources such as bandwidth, power, and memory are conserved as a user does not have to expend unnecessary resources correcting the inadvertent mistake.

Additionally, the centralized action system synthesizes information for the user and presents such information in a user-configurable arrangement. Extracted information and a status of actions across multiple documents is displayed to a user via a dynamic dashboard. Allowing users to manipulate the dynamic dashboard reduces computing resources associated with storing multiple documents.

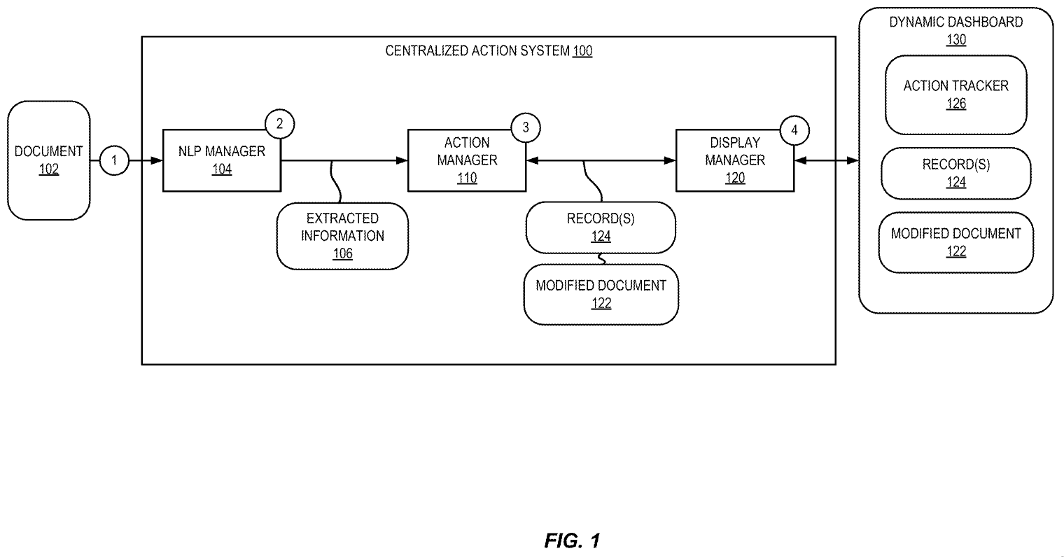

FIG. 1 illustrates a process of executing an action using extracted information, in accordance with one or more embodiments. As shown, FIG. 1 includes an NLP manager 104, an action manager 110, and a display manager 120.

As shown in FIG. 1, at numeral 1 the centralized action manager receives document 102. The document 102 may include any digital text file including one or more paragraphs or collections of text. For example, the document 102 may be a computer-generated document, or a scanned document (e.g., a digital representation of a physical document). The document 102 includes digital files with the following, or other, file extensions: .DOC, .DOCX, .PDF, .TXT, .HTML, .RTF, or .ODT. Centralized action system 100 may be implemented, for example, as a standalone service or as within a larger application or suite of applications. For example, the user may open document 102 using a document reader application. The centralized action system 100 may be implemented as part of the document reader application. In such an example, the document 102 may be provided to the centralized action system 100 when the user selects an icon, tool, or other user interface element within the document reader application associated with the centralized action system 100.

At numeral 2, a natural language processing (NLP) manager 104 receives the document 102. The NLP manager 104 may be any one or more NLP algorithms or models configured to extract information 106. For example, NLP algorithms or models executed by the NLP manager include descriptive language models, part of speech tagging models, n-grams, parse trees, and the like. In some embodiments, NLP models of the NLP manager 104 extract information 106 by searching for specific strings of characters within the document 102. Once a string is located, a number of characters before and/or after the string can be extracted as contextual information. Other NLP models extract information 106 by searching for semantic terms related to specific strings of characters within the document 102. Yet other NLP models may be off-the-shelf descriptive language models. For example, in one embodiment, NLP manager 104 is a generative pretrained transformer (GPT) model. These NLP models are neural networks that answer questions about the document 102 received in a prompt. In some embodiments, the prompt is a preconfigured list of questions to be extracted from the document 102. In other embodiments, the prompt is dynamically generated using any suitable method of prompt engineering.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The NLP manager 104 extracts information 106 from the document 102 such as actions, action parameters, triggers, action events, contextual information, and the like. As described herein, actions include an obligation to be performed; action parameters include information associated with the action such as the details regarding the performance of the obligation; triggers include information associated with initiating the action; action events include one or more steps associated with performing the action; and contextual information includes information contextualizing actions, action parameters, triggers, action events such as ordinal words, determiners, and the like. Further details of actions, action parameters, triggers, action events, and contextual information are described herein. The extracted information 106 can include words, phrases, summaries, and the like.

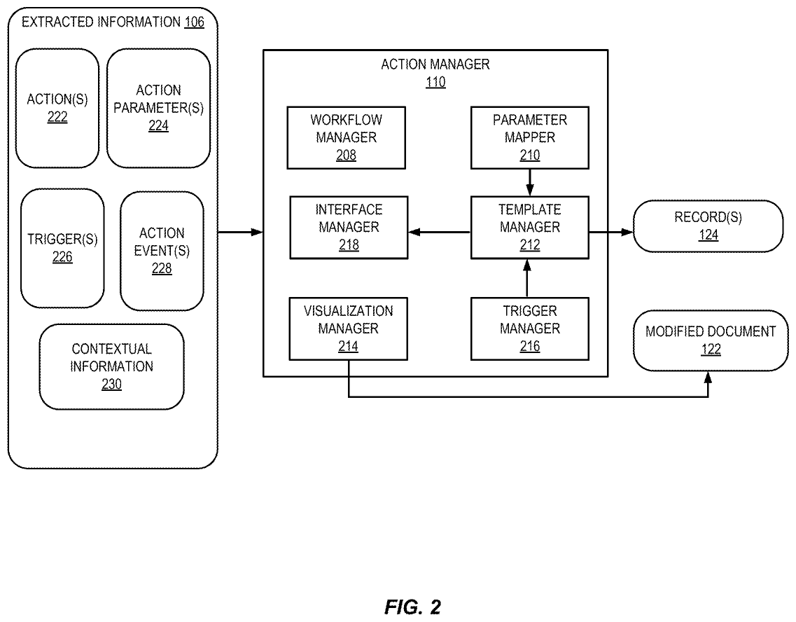

Once extracted information 106 has been identified by NLP manager 104, the NLP manager provides the extracted information 106 to the action manager 110. At numeral 3, the action manager 110 synthesizes the extracted information 106. Synthesizing the extracted information 106 is described in more detail with reference to FIG. 2. The synthesized information, in the form of record(s) 124 and modified document 122, is passed to the display manager 120. As described herein, a record 124 is a result of an executed action, and modified document 122 is a user-friendly view of extracted information 106 obtained from document 102. It should be appreciated that other synthesized information can be passed to the display manager 120 including a workflow, a status of trigger conditions, and the like. As described herein, a workflow is a sequence of action events (e.g., steps) associated with the action.

At numeral 4, the display manager 120 arranges information to be displayed to a user via dynamic dashboard 130. The display manager 120 arranges the dynamic dashboard 130 such that the user is displayed the document 102 and actions, action parameters, and triggers extracted from the document 102. The display manager 120 can also configure the dynamic dashboard 130 to display records 124. In this manner, a user may review generated records 124, approve records 124, and the like. The display manager 120 can also configure the dynamic dashboard to display modified document 122. In some embodiments, the display manager 120 arranges the dynamic dashboard 130 such that the user is displayed the modified document 122 (visually indicating portions of the document associated with extracted information) and actions, action parameters, and triggers extracted from the document 102.

Additionally or alternatively, the display manager 120 can configure the dynamic dashboard 130 to display an action tracker 126 summarizing extracted information across one or more documents. For example, the action tracker 126 may summarize previous actions, previous action parameters, and/or previous triggers extracted from previous documents. In some embodiments, the display manager displays a status of previous actions and/or action events using the action tracker 126. For example, the action tracker 126 may display action events that have been completed, action events that are pending, and action events that are not started (or some combination). In some embodiments, based on information from the action manager 110 (e.g., trigger manager 216, indicating that a trigger condition is not satisfied as described herein), the display manager 120 may display an action event in the action tracker 126 as pending using one or more colors, shapes, patterns, and the like.

In some embodiments, the display manager 120 arranges the dynamic dashboard 130 such that the user is displayed multiple variations of an action tracker 126. The display manager 120 automatically updates the action tracker 126 with extracted information 106 every time the centralized action system 100 receives a new document 102.

The arrangement of the summarized extracted information in the action tracker 126 is user-configurable. For example, a user may interact with the action tracker 126 of the dynamic dashboard 130 to rearrange columns or rows of the action tracker 126 in different orders, completely customizing the visualization of the extracted information. The action tracker 126 adjusts to the preferences of users by providing customization and flexibility via the display manager 120. Allowing users to rearrange the extracted information (and/or previously extracted information) visualizes information according to user preferences and can help users prioritize actions.

In some embodiments, the display manager 120 is configured to receive one or more user inputs using the dynamic dashboard 130. For example, the display manager 120 may receive a user input from the dynamic dashboard 130 modifying the extracted information from the input document 102, or modifying the extracted information from previously processed input documents. Specifically, the display manager 120 may receive a user input of user template preferences, a trigger condition not extracted from the document (e.g., user preference), an indication of a satisfied trigger condition, modifications to a workflow, and the like. Additionally or alternatively, a user may modify an action as being optional, modify a value of an action parameter, and the like. Specifically, the display manager 120 may receive a revision from the dynamic dashboard 130 including at least one of a revised action parameter, a revised trigger, an added action parameter, an added trigger, a removed action parameter, a removed trigger, and the like.

The display manager passes the revisions to the action manager 110. Subsequently, the action manager 110 distributes revisions to the corresponding module of the action manager 110. For example, a revised template is passed to the template manager 212 of the action manager 110 (described herein), the satisfied trigger condition is passed to the trigger manager 216 of the action manager 110 (described herein), and the like. The display manager 120 may also receive a user input associated with record 124. For instance, the user can approve the record, modify the record, and the like. Subsequently, the display manager 120 may pass the user input to the action manager 110 such that the template manager 212 (as described herein) is updated. The display manager 120 may also receive one or more user inputs modifying the visualization applied to modified document 122 (e.g., changing the color of a highlighted action). Subsequently, the display manager 120 passes such revisions to the action manager 110 such that visualization manager 214 (as described herein) updates modified document 122.

In some embodiments, the display manager 120 may display to the user one or more workflows associated with actions of the action tracker 126. As described herein, a workflow is a sequence of action events (e.g., steps) associated with the action. In some embodiments, the display manager 120 receives one or more user inputs associated with the displayed workflow. For example, the display manager 120 allows the user to edit the workflow (e.g., the workflow determined by the workflow manager 208 of the action manager 110 as described herein).

In some embodiments, information is extracted from the document 102 using information embedded in the document. For example, one or more modules may extract information from the document 102 that was embedded or otherwise coded by one or more upstream processes or third-party systems using code. For example, one or more modules may convert the document 102 into a JSON format. Subsequently, keys of key-value pairs are identified to determine actions, triggers, workflows, and the like. Additionally or alternatively, one or more modules may parse the code of the document 102 to identify reference tables. For example, if the document 102 is a PDF, the modules can be used to determine whether the File Specification Dictionary (e.g., a reference table in PDFs) contains a reference to an external file.

FIG. 2 illustrates example modules executed by the action manager to synthesize extracted information, in accordance with one or more embodiments. As shown, the action manager 110 may include, but is not limited to, executing modules such as the workflow manager 208, the parameter mapper 210, the template manager 212, the visualization manager 214, the trigger manager 216, and/or the interface manager 218 to synthesize the extracted information 106.

One module executed by the action manager 110 is the workflow manager 208. The workflow manager 208 is configured to determine a workflow (e.g., a sequence of action events) associated with each action. In some embodiments, the workflow manager 208 uses contextual information 230, and action events 228 to determine the workflow. For example, the workflow manager 208 determines a workflow by mapping ordinal words like “first” and “second” to action events. In some embodiments, a workflow sequencing steps A and B is determined by the workflow manager 208 responsive to phrases such as “First . . . step A” and “then step B.” In other embodiments, the workflow manager 208 receives a workflow extracted using the embedded information extraction manager.

In some embodiments, the workflow manager 208 queries one or more datastores, databases, applications, servers, and the like, to obtain predetermined workflows. A predetermined workflow is a workflow determined by one or more users. Additionally or alternatively, the predetermined workflow can be determined by the workflow manager 208 from previously extracted information of previous documents. For example, some predetermined workflows may be universal workflows, where universal action events are supplemented into any workflow associated with a particular action. Such universal workflows are extracted from controlling documents such as master agreements, appendices, company policies, and the like. An example of a universal action event includes notifying a particular person responsive to performing any payment (e.g., payment actions). Another example of a universal action event includes notifying a person responsive to any communication (e.g., communication actions).

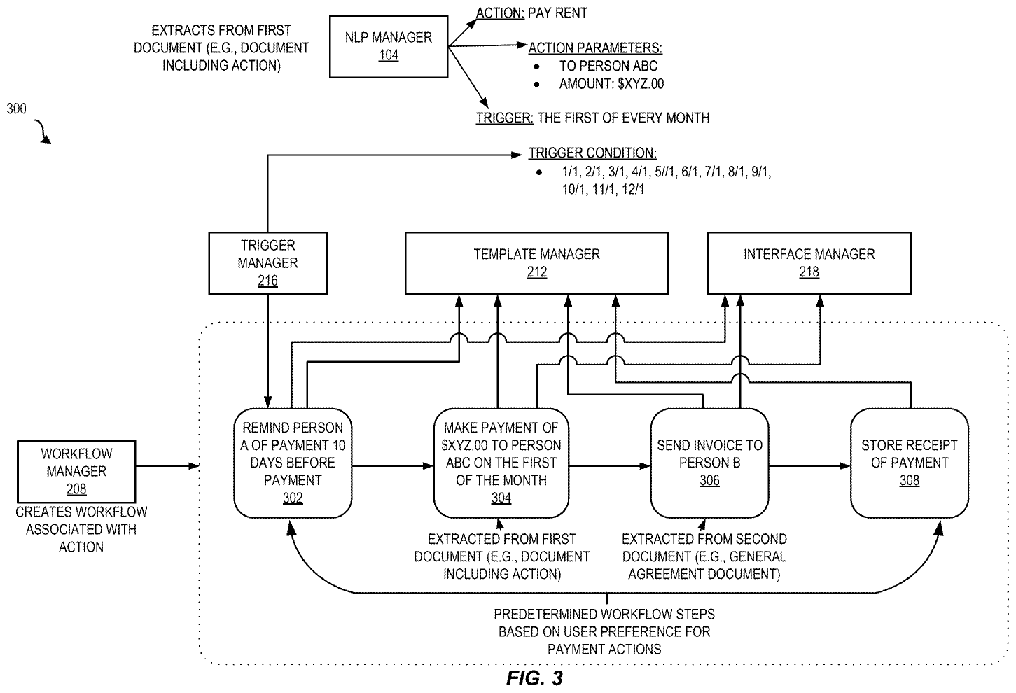

The workflow manager 208 determines to obtain a predetermined workflow by mapping an action 222 to one or more catalogs, lists, or other data structures of stored actions associated with predetermined workflows. Responsive to matching the action 222 to a stored action associated with a predetermined workflow, the workflow manager 208 retrieves the predetermined workflow. In some embodiments, a “communication” action (e.g., action 222) is mapped to a “communication” predetermined workflow stored in a database. The workflow manager 208 then supplements a workflow determined from the extracted information 106 with the predetermined workflow. For example, the workflow manager 208 integrates action events of a first workflow (a workflow determined using extracted information 106) with one or more action events of a second workflow (a predetermined workflow). Retrieving a predetermined workflow and supplementing the predetermined workflow with extracted information 106 is explained in more detail with reference to FIG. 3.

Another module executed by the action manager 110 is the parameter mapper 210. The parameter mapper 210 is configured to map action parameters to actions. As described herein, action parameters include information associated with the action such as the details regarding the performance of the action. For example, given a payment action, associated action parameters can include when the payment should be made, how much the payment should be, to whom the payment should be made to, what forms of payment are acceptable, and the like. In addition, other action parameters associated the payment action include non-payment related tasks such as notifying the second party of the payment and recording the payment for the first party's record keeping purposes.

The parameter mapper 210 uses the received actions 222 and action parameters 223 to map multiple action parameters and multiple actions. In a first example, a first action 222a relates to paying a financial officer for a particular product. In the example, a second action 222b relates to paying late fees to the financial officer. The parameter mapper 210 maps the action parameter 224 (e.g., the financial officer) to both the first action 222a associated with paying for a product, and the second action 222b associated with paying late fees. In a second example, the phrase “all communications to XYZ entity must include ABC person” has been extracted from a document. The parameter mapper 210 may map communication with ABC person (e.g., an action parameter 224) to each action that involves communication with XYZ entity. Using the contextual information 230 (and specifically determiner words such as “all”), the parameter mapper 210 creates a universal action event by mapping an action parameter (communication with ABC person) with any/all actions that involves the XYZ entity (another action parameter). In a third example, information extracted from the document may include the phrase “contact the human resources representative to terminate your employment.” As described herein, the parameter mapper 210 may map “human resources representative” (the action parameter 224) and “terminate employment” (the action 222). In some embodiments, the parameter mapper 210 queries one or more data stores to determine a name of the human resource representative, contact information of the human resource representative, and other information associated with the action (terminate employment).

Another module executed by the action manager 110 is the template manager 212. The template manager 212 is configured to generate record 124, which is a product of an executed action. Referring to FIG. 1, record 124 is one example of synthesized information that can be provided to the display manager 120 for display to a user. The template manager 212 selects a template corresponding to the action and generates a record by copying the selected template. The record is then populated with information received from the parameter mapper 210 (e.g., actions, action parameters, etc.). By populating the template copy to create a record 124 (and/or creating a record 124 from a blank document using a machine learning model), the template manager 212 executes the action and/or executes an action event in a sequence of action events associated with the action.

In some embodiments, a template selected by the template manager 212 may be an invoice. The template manager 212 copies the invoice template, generating a record. Subsequently, the template manager 212 populates the invoice with action parameters 224 such as the parties involved in the agreement, the payment amount, the method of the payment, the date the payment was paid (or is to be paid), a date, contact information, and the like.

The template manager 212 may also populate fields of the template copy with action parameters mapped by the parameter mapper 210. As described herein, the parameter mapper 210 may query a datastore for information associated with an action parameter. Subsequently, the parameter mapper 210 provides the information associated with the action parameter to the template manager 212. In this manner, the template manager 212 populates the template copy with queried information associated with an action.

In some embodiments, the template manager 212 generates records 124 immediately (e.g., at a time period near/after receiving extracted information 106). In other embodiments, the template manager 212 generates a record 124 responsive to an indication from the trigger manager 216. As described herein, the trigger manager 216 determines when a trigger condition has been satisfied. Responsive to determining the trigger condition has been satisfied, the trigger manager 216 prompts the template manager 212 to generate record 124. In some embodiments, when the template manager 212 generates the record 124, a user is alerted of the generated record 124 such that the user can review the record (e.g., via dynamic display 130).

In operation, the template manager 212 selects a template from one or more catalogs, lists, or other data structures of stored actions and corresponding templates. For example, a payment action may be associated with an invoice template, while a communication action may be associated with an email template. There may be multiple templates associated with an action. For example, a payment action may be associated with an invoice template and a receipt template.

In some implementations, the template manager 212 obtains all templates associated with the action. In other implementations, the template manager 212 performs additional mapping to select a template from multiple templates associated with an action. For example, the template manager 212 maps an action 222 to a group of templates (e.g., using a lookup table or other data structure). Subsequently, the template manager 212 selects a template from the group of templates based on action parameters 224 and/or action events 228. For instance, the template manager 212 may perform string matching to obtain an “invoice” template associated with an “invoice” action event of a sequence of action events associated with a payment action. In this manner, the template manager 212 obtains the specific invoice template needed to execute the action event of the workflow associated with the payment action, instead of obtaining other templates in the group of templates associated with payment actions (e.g., a receipt template).

In some embodiments, the template manager 212 selects a template associated with a particular entity (e.g., user, corporation, etc.). For example, the template manager 212 may select User X's receipt template responsive to receiving User X (action parameter 224) and payment actions (action 222). The template manager 212 matches the action parameter and action to a list, catalog, or other data structure storing actions and corresponding stored templates.

Additionally or alternatively, the template manager 212 generates record 124 using one or more language modules and/or a GPT model (e.g., without a selected template). The template manager 212 may generate the record 124 by feeding the language model a prompt including the extracted information 106. Examples of record 124 include an invoice, a receipt, a draft email, a calendar invitation, and the like.

Another module executed by the action manager 110 is the trigger manager 216. The trigger manager 216 receives triggers 226, and tracks triggers associated with actions. As described herein, each trigger initiates an action (or an action event of an action) responsive to a trigger condition. Table 1 below describes the relationship between triggers, actions, and trigger conditions. Generally, trigger conditions are parameters associated with an action (or an action event). Accordingly, trigger conditions are also referred to herein as action parameters, and may be extracted from a document 102 according to the processes described herein.

TABLE 1
Relationship between triggers, actions, and trigger conditions

| Trigger | Action | Trigger Condition |
|---|---|---|
| Ten days after signing | Payment | The tenth day after |
| the contract | | signing the contract |

As shown in Table 1 above, while a trigger may describe a general time period to initiate the action, the trigger condition is an actual date to initiate the action. The trigger manager 216 may interface with a calendar or other application to determine the trigger condition (e.g., a date in month-day-year format) associated with the trigger (e.g., a description of a date).

The trigger manager 216 tracks triggers 226 associated with action by determining whether one or more trigger conditions associated with the action are satisfied. In some embodiments, when the trigger manager 216 determines that a trigger condition is satisfied, a user is alerted/notified of the satisfied trigger condition. In some embodiments, the trigger manager 216 initiates a counter to track a predetermined number of days. Responsive to the counter reaching the predetermined number of day threshold, the trigger manager 216 determines that the trigger condition is satisfied. In some embodiments, the trigger manager 216 queries one or more sensors, such as video cameras, weather sensors, and the like, to determine whether a trigger condition is satisfied. For instance, information extracted from a document may include a trigger associated with shipping a widget responsive to a weather condition. In this example, the trigger manager 216 polls one or more weather sensors to determine whether the trigger condition has been satisfied, based on a status of a weather condition. Responsive to, for example, a likelihood of rain satisfying a threshold, the trigger manager 216 determines that the trigger condition has been satisfied. In a different example, the trigger manager 216 determines that the trigger condition has been satisfied responsive to receiving a user input indicating that the trigger condition has been satisfied.

In some embodiments, the trigger manager 216 maintains a table mapping actions to predetermined triggers. Predetermined triggers are triggers determined by users based on user preferences, company policy, and the like. In some embodiments, it may be company policy to alert Person A of an upcoming payment X number of days before the payment. Accordingly, the trigger (alerting person A of an upcoming payment X number of days before the payment) corresponds to the action (payment). Using string matching or some other suitable matching technique, the trigger manager 216 matches an action 222 to one or more predetermined triggers. Predetermined trigger conditions are managed and tracked the same as triggers 226.

The trigger manager 216 is also responsible for tracking triggers and corresponding trigger conditions previously extracted. In this manner, the centralized action system 100 is able to track and execute multiple actions of multiple documents. For example, the trigger manager 216 can track triggers associated with an action extracted from a first document between Party A and Party B. The trigger manager 216 can also track triggers associated with a second action in a second document between Party A and Party C.

Another module executed by the action manager 110 is the visualization manager 214. The visualization manager 214 is configured to overlay one or more visual indicators indicating portions of the document corresponding to extracted information 106 such as action parameters 224, actions 222, triggers 226, and the like. In this manner, the visualization manager 214 creates a modified document 122, which is a user-friendly view of extracted information 106. Referring briefly to FIG. 1, the modified document 122 is one example of synthesized information that can be provided to the display manager 120 for display to a user.

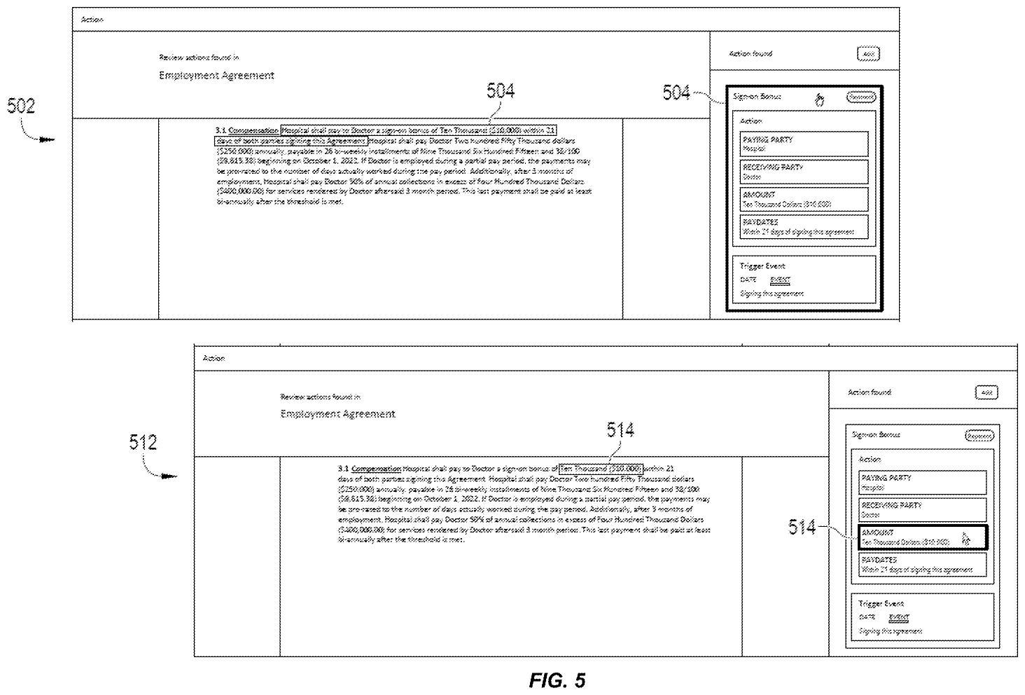

An example of the operations performed by the visualization manager 214 is illustrated in FIG. 5 described below. In some embodiments, the visualization manager 214 may overlay one or more colors on the extracted information of modified document 122. Additionally or alternatively, the visualization manager 214 may underline the extracted information (using one or more colors), or modify one or more attributes of the extracted information in modified document 122 (e.g., italicize the extracted information, increase or decrease the font size of the extracted information, and the like). In some implementations, the visualization manager 214 adds objects, patterns, notes, etc. to the modified document 122 at the location of the extracted information.

Another module executed by the action manager 110 is the interface manager 218. The interface manager 218 is configured to interface with one or more data stores, applications, computing devices, and the like. For example, the interface manager 218 can interface with a calendar application, creating a calendar reminder associated with a trigger 226. Additionally or alternatively, the interface manager 218 can cause a pop-up to be displayed on the dynamic dashboard 130, alerting the user of a satisfied trigger condition or a generated record 124. In some embodiments, the interface manager 218 requires one or more permissions and/or authentication credentials before interfacing with external servers, applications, data stores, and the like.

In some embodiments, the interface manager 218 interfaces with a computing device. The interface manager 218 transmits record 124 generated by the template manager 212 to a computing device external to the centralized action system 100. For example, the interface manger 218 interfaces with an email application to mail a status report email (record 124) to a third party. In some embodiments, responsive to a trigger condition being satisfied, the template manager 212 generates the record 124. The interface manager 218 may transmit a notification to one or more users that the interface manager 218 interfaced with one or more external computing devices. That is, after the interface manager 218 sent the email, the interface manager 218 notifies one or more users.

The interface manager 218 may be configured to call one or more application programming interfaces (API). The API is used to communicate with a server using API calls (or API requests). In response to the API call, the interface manager 218 receives data used to provide functionality and/or services of the interface manager 218. In a particular example, the interface manager 218 can provide extracted information to a remote application using the API. As a result, the remote application performs a function. For example, the interface manager 218 communicating to a banking application via a banking API may result in the banking application withdrawing money from an account and depositing such money into a different account, when the amount to be withdrawn from the account is provided by the API.

FIG. 3 illustrates an example workflow and the corresponding action events and action parameters associated with the workflow, in accordance with one or more embodiments. As shown, actions, action parameters, and triggers are extracted from a document. For example, the NLP manager 104 may extract such information. As shown, the trigger manager 216 may determine trigger conditions associated with the extracted trigger. In one implementation, the trigger manager 216 may determine the trigger conditions using the trigger extracted from the document (e.g., the first of every month) and a calendar application. In another implementation, the trigger conditions may be specifically listed in the document such that the NLP manager 104 extracts the trigger conditions.

As described herein, the centralized action system 100 executes the extracted actions by executing each action event of a workflow associated with the action. As described herein, the workflow includes a series of sequential steps (action events) to be performed for the completion of a particular action. As shown, the workflow determined by the workflow manager 208 includes steps 302-308 associated with the action (e.g., paying rent). As described herein, the workflow manager 208 determines the workflow using the extracted information of the document. Additionally or alternatively, the workflow manager 208 obtains a predetermined workflow associated with the action and supplements the predetermined workflow with extracted information.

As shown, action event 302 and 308 are part of a predetermined workflow that the workflow manager 208 supplements with extracted information. As described herein, the workflow manager 208 may map the action “pay” to a list of stored actions and corresponding templates of workflows. Responsive to the workflow manager 208 matching “pay” to a stored “pay” workflow template, the workflow manager 208 supplements a copy of the pay template workflow with additional information extracted from the document (e.g., action events 304 and 306). In this manner, the workflow associated with the action (including action events from multiple workflows) is created.

The action event 302 includes a reminder of the upcoming payment. The centralized action system 100 can execute action event 302 using the interface manager 218 to interface with a calendar application. For example, the interface manager 218 can interface with the calendar application to create a calendar reminder for Person A. The trigger manager 216 triggers the template manager 212 to generate the reminder (or execute action event 304) 10 days before the payment. Subsequently the interface manager 218 uses the calendar application to display the generated reminder to Person A. In the above example, the trigger manager 216 tracks the trigger condition associated with the payment (e.g., the first of event month) and the trigger condition associated with the reminder (e.g., 10 days before the payment).

The action event 304 includes the action extracted from the document. As shown, the action event includes the parameters of the action (e.g., the amount of the payment, $XYZ.00, the recipient of payment Person ABC). In some embodiments, action event 304 is executed by a user. The user may input a completion of the payment. As shown, the action event 304 is executed using the interface manager 218 to interface with one or more financial applications. For example, the interface manager 218 may initiate the transfer of funds. As described herein, the trigger manager 216 triggers the interface manager 218 to initiate the transfer on the first of the month.

The action event 306 is a universal action event associated with another predetermined workflow. As described herein, the workflow manager 208 supplements any workflow associated with a particular action with universal actions. In example 300, the universal action event 306 has been extracted from a different document such as a general agreement document (or a master agreement document, supplemental agreement document, appendix, etc.). The general agreement document is an example document providing predetermined workflows including universal action events. In the example 300, the payment action extracted from the first document triggered the workflow manager 208 to incorporate the universal action event associated with the payment action determined from the second document.

Executing the action event 306 includes sending an invoice to Person B. As described herein, the action event 306 may be executed responsive to the template manager 212 generating a draft email to Person B. The template manager 212 populates a copy of the draft email with the date of the payment, the amount of the payment, the recipient of the payment, or any other action parameter. As described herein, the template manager 212 may interface with the interface manager 218 to automatically send the email responsive to the payment being made in action event 304 (e.g., an indication by a user that the payment was made, the initiation of the payment via a financial application by the interface manager 218, etc.).

The template manager 212 can also generate the invoice attached to the email. As described herein, the template manager 212 selects an invoice to populate based on the action extracted from the document being a payment action. For instance, the template manager 212 maps the extracted payment action to a stored invoice template associated with payment actions. The template manager 212 populates a copy of the invoice template with action parameters, triggers, trigger conditions, and/or supplemental information obtained by the parameter mapper 210 to generate the invoice (e.g., a record).

The action event 308 stores receipt of the payment executed at action event 304. The centralized action system 100 can execute action event 308 using the template manager 212 to generate a receipt. The template manager 212 can generate a receipt similar to how the template manager 212 generated the invoice (e.g., described in action event 306). For example, the template manager 212 can select a template receipt from multiple templates associated with a payment action by matching the word “receipt” of the action event 308 to each name of the multiple templates associated with the payment action. In this manner, the template manager 212 selects the “receipt” template from multiple templates. In some implementations, the template manager 212 stores the receipt. In other implementations, the template manager 212 interfaces with the interface manager 218 to interface with one or more servers, databases, cloud environments, or the like to store the receipt.

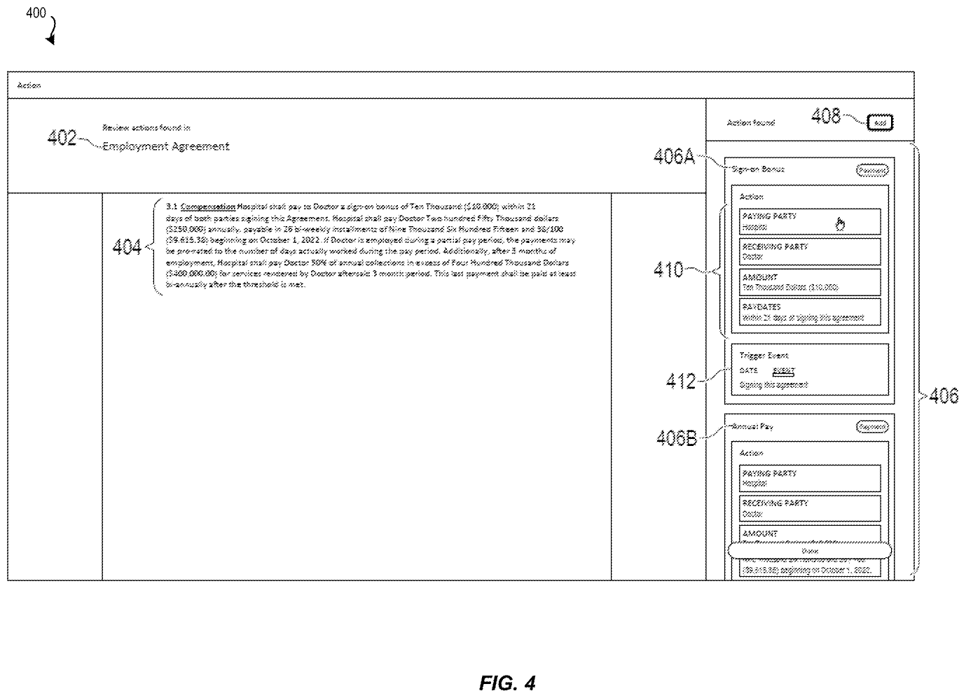

FIG. 4 illustrates an example of the centralized action system visualizing extracted information from a document, in accordance with one or more embodiments. As shown, the dynamic dashboard 400 can display extracted information such as an actions, triggers, and action information. Specifically, at 402, the dashboard 400 displays the title of the document. The document itself is shown at 404. At 406, the dashboard 400 displays the extracted actions 406A and 406B from document 404. As shown, both actions 406A and 406B are payment actions, with action 406A being a payment associated with a sign-on bonus, and action 406B being a payment associated with a salary. As shown at 410, action parameters of extracted action 406A including the paying party, the receiving party, and an amount, are visualized. As shown at 412, the trigger associated with action 406A is displayed. At 408, the user may interact with dashboard 400 to add information such as actions, parameters, conditions, or other information extracted from document 404.

FIG. 5 illustrates examples of interacting with extracted information using the centralized action system, in accordance with one or more embodiments. As described herein, the visualization manager 214 may highlight portions of the document associated with extracted information. As shown, dashboard 502 illustrates an example visualization of a user interacting with an extracted action. For example, the user may be interested in identifying where such action information was extracted from within the document. Responsive to receiving a selection of the extracted action, the centralized action system 100 visually indicates the corresponding portion of the document. Specifically, the dashboard 502 maps the extracted action to the portion of the document in which the action was extracted from, indicated at 504. Similarly, dashboard 512 illustrates an example visualization of a user interacting with an action parameter. Responsive to receiving a selection of the action parameter, the centralized action system 100 visually indicates the corresponding portion of the document. Specifically, the dashboard 512 maps the extracted action parameter to the portion of the document in which the action parameter was extracted from, indicated at 514.

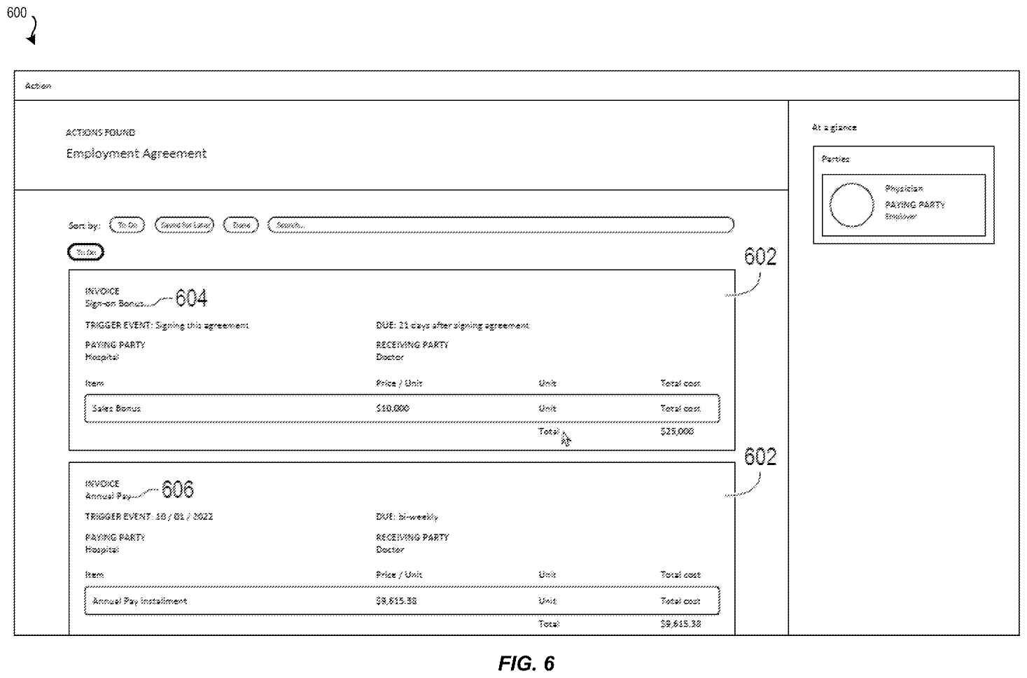

FIG. 6 illustrates an example visualization of extracted information using an action tracker, in accordance with one or more embodiments. In some embodiments, a user may determine to execute an action. For example, after the user reviews the extracted actions from the document (as shown in FIGS. 4-5), the user may execute one or more extracted actions and/or action events. As shown, the user may select an action to execute in a centralized action dashboard 600. The dashboard 600 indicates actions (e.g., 604 and 606) and extracted action parameters associated with the actions. As indicated in FIG. 4, both action 604 and 606 are payments. An action to be executed responsive to both action payment actions 604 and 606 is the generation of an invoice 602. As described herein, the invoice 602 may be a copy of a template invoice that is populated with information corresponding to an action (e.g., action 604 or action 606). In some embodiments, the invoice is generated responsive to a user input. In other embodiments, the invoice is generated responsive to a satisfied trigger condition. As shown, two actions 604 and 606 have been extracted from a single document. However, it should be appreciated that actions and action parameters extracted from previous documents may be displayed using the action tracker of dashboard 600. As described herein, a user may dynamically adjust the actions/action parameters displayed on dashboard 600. For example, actions may be displayed alphabetically, with respect to the most recently extracted actions, with respect to actions with upcoming trigger conditions, and the like.

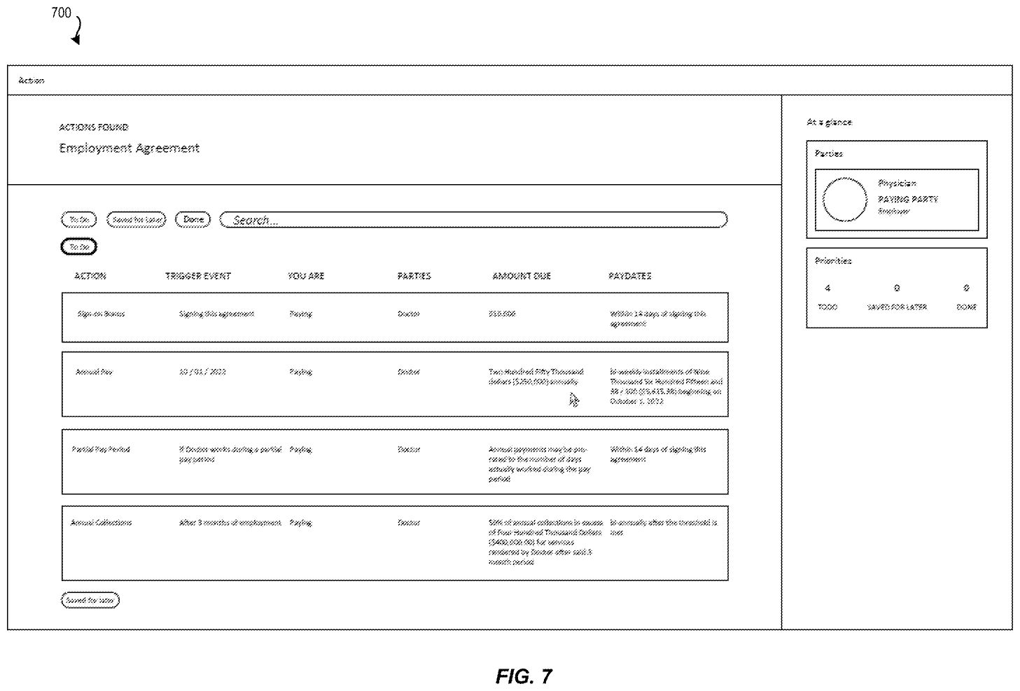

FIG. 7 illustrates an alternate visualization of an action tracker displayed on dashboard 700, in accordance with one or more embodiments. As illustrated in dashboard 700, the information extracted from the document can be presented to the user in various ways. In other embodiments (not shown), the dashboard 700 can be similar to that of a project planning board. For example, information extracted from the document can be visually mapped (e.g., linked) to parameters, triggers, or other information associated with the action.

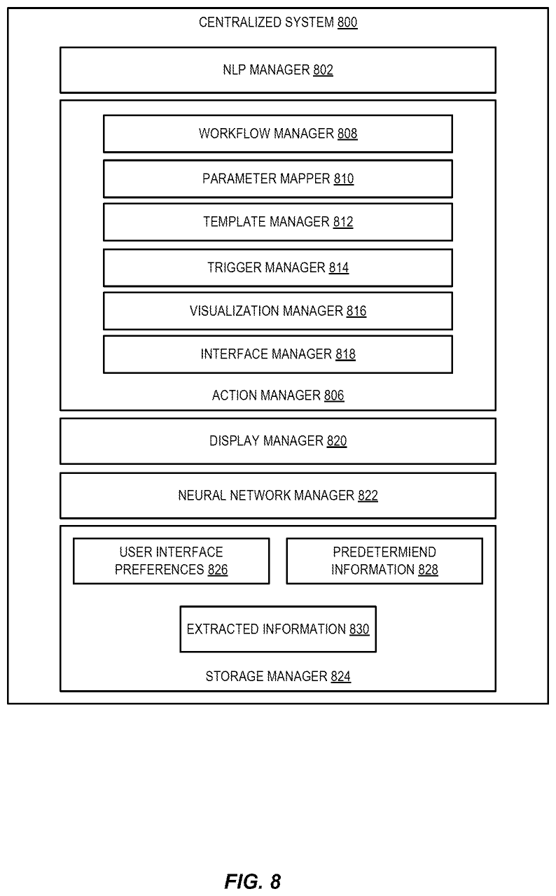

FIG. 8 illustrates a schematic diagram of the centralized action system (e.g., “centralized action system” described above) in accordance with one or more embodiments. As shown, the centralized action system 800 may include, but is not limited to, a NLP manager 802, an action manager 806, a user interface manager 820, a neural network manager 822, and a storage manager 824. The action manager 806 includes a workflow manager 808, a parameter mapper 810, a template manager 812, a trigger manager 814, a visualization manager 816, and an interface manager 818. The storage manager 824 includes user interface preferences 826, templates 828, and extracted information 830.

As illustrated in FIG. 8, the centralized action system 800 includes a NLP manager 802. The NLP manager 802 may be any one or more NLP algorithms or models configured to understand free text. The NLP manager 802 extracts information associated with actions, triggers, and workflow from a document.

As illustrated in FIG. 8, the centralized action system 800 includes an action manager 806. The action manager 806 executes modules to synthesize information extracted from a document. As shown, the action manager 806 includes a workflow manager 808. The workflow manager 808 is configured to determine a workflow associated with each action. Specifically, the workflow manager 808 determines a sequence of action events corresponding to the action from the content of the document. The workflow manager 808 can supplement a predetermined workflow using action events corresponding to the action extracted from the document. The workflow manager 808 can also supplement action events of a first workflow with action events of a second workflow.

The action manager 806 also includes a parameter mapper 810. The parameter mapper 810 map action parameters to actions. The parameter mapper 810 can also map multiple action parameters and multiple actions. For example, universal action events are mapped to multiple actions. As described herein, action parameters include extracted information associated with an action.

The action manager 806 also includes a template manager 812. The template manager 812 generates a record (or a result of an action) by populating information in copies of selected templates with information extracted from the document. A template is selected from a collection stored templates based on the action extracted from the document, an entity, and/or an action parameter extracted from the document. Additionally or alternatively, the template manager 812 generates records by generating a document using machine learning models (such as language models) given a prompt including information extracted from the document.

The action manager 806 also includes a trigger manager 814. The trigger manager 814 tracks triggers associated with each action. As described herein, each trigger initiates an action responsive to a trigger condition. The trigger manager 814 determines when a trigger condition is satisfied for each of the managed triggers of the trigger manager 814. As described herein, the trigger manager 814 is configured to manage multiple actions of multiple documents.

The action manager 806 also includes a visualization manager 816. The visualization manager 816 is configured to overlay one or more visual indicators indicating portions of the document corresponding to extracted information such as action parameters, actions, triggers, and the like.

The action manager 806 also includes the interface manager 818. The interface manager 818 is configured to interface with the modules of the action manager 806 and one or more data stores, applications, computing devices, and the like. In this manner, the interface manager 818 can provide each of the modules of the action module 806 with additional information not obtained from the document. In some embodiments, the interface manager 818 requires one or more permissions and/or authentication credentials before interfacing with external servers, applications, data stores, and the like. To interface with the data stores, applications, and/or computing devices, the interface manager 1P18 may call one or more APIs and/or query data stores, databases and/or computing devices directly.

As illustrated in FIG. 8, the centralized action system 800 includes a display manager 820. The display manager 820 configures a dynamic dashboard for display to the user. As described herein, the display manager 820 can display extracted information of a particular document next to the document (or a modified document) used to extract such information. Additionally or alternatively, the dynamic dashboard can display the action tracker, summarizing extracted information across one or more documents. The dynamic dashboard can also display records, or a result of the executed action.

The display manager 820 is also configured to receive one or more user inputs. For example, a user can approve a displayed record, review the displayed record, modify the displayed record, and the like. Additionally or alternatively, the display manager 820 can receive an input modifying the arrangement of extracted information on the action tracker. The display manager 820 may also receive inputs revising extracted information such as revised actions, revised action parameters, revised triggers, and the like. Other inputs received by the display manager 820 include inputs modifying the visual appearance of the modified document (e.g., the document overlaying a visual indicator on top of portions of the document corresponding to extracted information). As described herein, the display manager 820 is configured to pass information received from a user input to one or more modules of the action manager 806.

The display manager 820 also allows user to provide documents to the centralized action system 800. Alternatively, or additionally, the display manager 820 may enable the user to download the documents from a local or remote storage location (e.g., by providing an address (e.g., a URL or other endpoint) associated with the document).

As illustrated in FIG. 8, the centralized action system 800 includes a neural network manager 822. The neural network manager 822 may host a plurality of neural networks or other machine learning models such as language models described herein. The neural network manager 822 may include an execution environment, libraries, and/or any other data needed to execute the machine learning models. In some embodiments, the neural network manager 822 may be associated with dedicated software and/or hardware resources to execute the machine learning models. In various embodiments the neural networks may be hosted in multiple neural network managers and/or as part of different components. For example, each neural network/machine learning model can be hosted by their own neural network manager, or other host environment, in which the respective neural networks execute, or the neural networks/machine learning models may be spread across multiple neural network managers depending on, e.g., the resource requirements of each of the neural networks, etc.

As illustrated in FIG. 8, the centralized action system 800 includes a storage manager 824. The storage manager 824 maintains data for the centralized action system 800. The storage manager 824 can maintain data of any type, size, or kind as necessary to perform the functions of the centralized action system 800. The storage manager 824, as shown in FIG. 8, includes user interface preferences 826. User preferences 826 may include particular arrangements of extracted information displayed to a particular user via the action tracker. For example, a particular user may prefer a particular arrangement of actions and triggers in certain rows/columns.

As further illustrated in FIG. 8, the storage manager 824 also includes predetermined information 828. Predetermined information 828 includes templates (e.g., copied by the template manager 812 to create a record), predetermined workflows (e.g., sequences of action events determined by previous documents fed to the centralized action system 800, user preferences, company policy, and the like), predetermined triggers (e.g., triggers set by user preferences, company policy, and the like). As described herein, one or more modules of the action manager 806 uses string matching (or any other suitable technique) to compare strings extracted from the document to predetermined information 828. Responsive to matching strings of extracted information to strings of the predetermined information, the storage manager 824 retrieves the predetermined information 828.

As further illustrated in FIG. 8, the storage manager 824 also includes extracted information 830. Extracted information 830 includes actions, triggers, embedded workflows, action parameters, and the like. Extracted information 830 can be stored in the storage manager 824 of any previous document fed to the centralized action system 800.

Each of the components of the centralized action system 800 and their corresponding elements (as shown in FIG. 8) may be in communication with one another using any suitable communication technologies. It will be recognized that although components and their corresponding elements are shown to be separate in FIG. 8, any of components and their corresponding elements may be combined into fewer components, such as into a single facility or module, divided into more components, or configured into different components as may serve a particular embodiment.

The components and their corresponding elements can comprise software, hardware, or both. For example, the components and their corresponding elements can comprise one or more instructions stored on a computer-readable storage medium and executable by processors of one or more computing devices. When executed by the one or more processors, the computer-executable instructions of the centralized action system 800 can cause a client device and/or a server device to perform the methods described herein. Alternatively, the components and their corresponding elements can comprise hardware, such as a special purpose processing device to perform a certain function or group of functions. Additionally, the components and their corresponding elements can comprise a combination of computer-executable instructions and hardware.

Furthermore, the components and corresponding elements of the centralized action system 800 may, for example, be implemented as one or more stand-alone applications, as one or more modules of an application, as one or more plug-ins, as one or more library functions or functions that may be called by other applications, and/or as a cloud-computing model. Thus, the components and corresponding elements of the centralized action system 800 may be implemented as a stand-alone application, such as a desktop or mobile application. Furthermore, the components and corresponding elements of the centralized action system 800 may be implemented as one or more web-based applications hosted on a remote server. Alternatively, or additionally, the components and corresponding elements of the centralized action system 800 may be implemented in a suite of mobile device applications or “apps.”

As shown, the centralized action system 800 can be implemented as a single system. In other embodiments, the centralized action system 800 can be implemented in whole, or in part, across multiple systems. For example, one or more functions of the centralized action system 800 can be performed by one or more servers, and one or more functions of the centralized action system 800 can be performed by one or more client devices. The one or more servers and/or one or more client devices may generate, store, receive, and transmit any type of data used by the centralized action system 800, as described herein.

In one implementation, the one or more client devices can include or implement at least a portion of the centralized action system 800. In other implementations, the one or more servers can include or implement at least a portion of the centralized action system 800. For instance, the centralized action system 800 can include an application running on the one or more servers or a portion of the centralized action system 800 can be downloaded from the one or more servers. Additionally or alternatively, the centralized action system 800 can include a web hosting application that allows the client device(s) to interact with content hosted at the one or more server(s).

For example, upon a client device accessing a webpage or other web application hosted at the one or more servers, in one or more embodiments, the one or more servers can provide access to the centralized action system 800 stored at the one or more servers. In some embodiments, the client device is used to upload one or more documents. Upon receiving the uploaded document, the one or more servers can automatically perform the methods and processes described above to execute extracted information from the document. The one or more servers can communicate a dynamic display to the user. As described herein, a user uses the client device to view the dynamic display. The dynamic display can display the uploaded document, a modified document, a summary of extracted information, a record associated with an executed action extracted from the document, and the like. The arrangement of information displayed on the dynamic display is user configurable such that a user may interact with the client device and subsequently, the one or more servers make adjustments to the dynamic display based on the user interaction with the dynamic display.

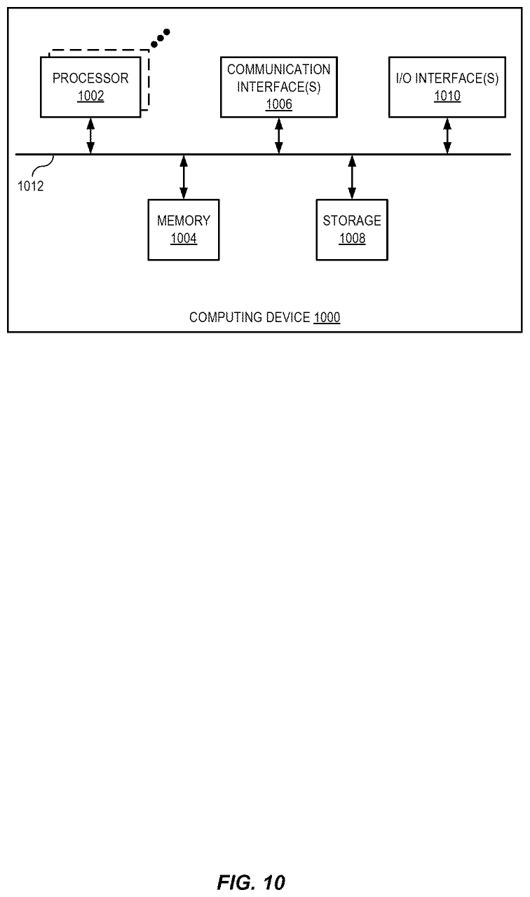

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

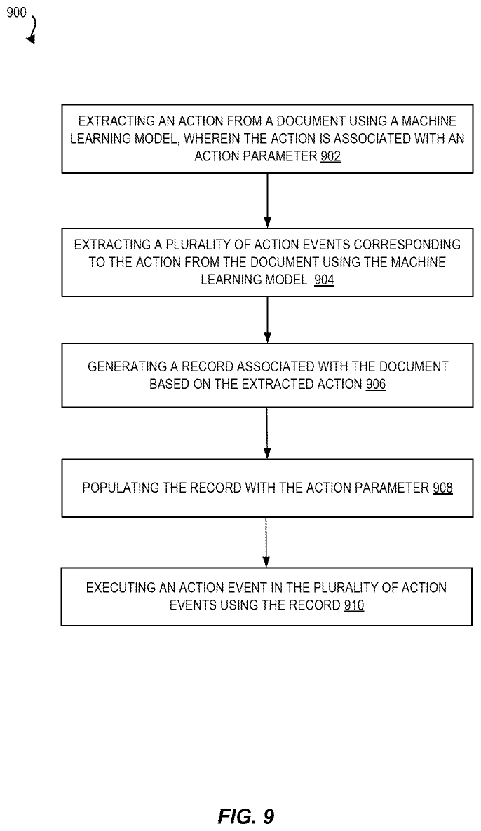

FIGS. 1-8, the corresponding text, and the examples, provide a number of different systems and devices that allows a user to automatically execute an action using information extracted from a document. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart 900 of a series of acts in a method of executing an action using information extracted from a document in accordance with one or more embodiments. In one or more embodiments, the method 900 is performed in a digital medium environment that includes the centralized action system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of extracting an action from a document using a machine learning model, wherein the action is associated with an action parameter. As described herein, an action is an obligation of a party, where the specifics of the obligation are defined according to the action parameters associated with the action. For example, action parameters can include a price associated with an action (e.g., a payment), a time associated with an action (e.g., notice), one or more people associated with an action (e.g., contact information), and the like. As described herein, the NLP manager 104 extracts strings from the document, identifies semantically related information in the document, and/or answers questions about the document to obtain actions, action parameters, triggers, and the like. In this manner, the action manager 110 receives extracted information from the document.

As illustrated in FIG. 9, the method 900 includes an act 904 of extracting a sequence of action events corresponding to the action from the document using the machine learning model. For example, the NLP manager 104 extracts a sequence of action events using the context of the natural language of the document. In some embodiments, the embedded information extraction manager extracts a workflow associated with an action of the document using embedded code. The workflow manager 208 of the action manager 110 determines a sequence of actions associated with an action based on the information from the NLP manager 104 such as the context extracted from the document, predetermined workflows (e.g., user preferences, company policy, previously extracted workflows), and the like.

As illustrated in FIG. 9, the method 900 includes an act 906 of generating a record associated with the document based on the extracted action. As described herein, the template manager 212 can select a template based on the extracted action by comparing one or more strings of the extracted action to one or more stored templates. The template manager 212 copies the stored template and populates the copy of the template to generate a record.

As illustrated in FIG. 9, the method 900 includes an act 908 of populating the record with the action parameter. As described herein, the template manager 212 populates the record (e.g., the copy of the template) with information extracted from the document 102 and/or information obtained by one or more modules of the action manager 110. As described herein, by populating the copy of the template (e.g., the record), the template manager 212 is executing an action. Examples of populated record 124 include an invoice, a receipt, a draft email, a calendar invitation, and the like.

As illustrated in FIG. 9, the method 900 includes an act 910 of executing an actin event in the sequence of action events. As described herein, the sequence of action events is a workflow associated with the action. The sequence of action events can include an action such as transmitting the record, storing the record, requesting approval of the record, and the like. For example, the action event can include printing a document, emailing the document, and the like. The interface manager 218 may transmit records 124 for approval by a user, by transmitting the record 124 to a user device. For instance, the interface manager 218 may transmit the record 124 to a user device external to the centralized action system 100. Additionally or alternatively, the interface manager 218 transmits records 124 to a computing device without approval from a user. For example, responsive to a trigger condition being satisfied, the template manager 212 generates and populates the record with information and transmits the record 124 to a user device. The interface manager 218 may interface with servers, databases, cloud environments internal or external to the centralized action system 100 or the like to store and/or transmit the records 124.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the centralized action system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B. or at least one of C to each be present.

We claim:

1. A method comprising:
extracting an action from a document using a machine learning model, wherein the action is associated with an action parameter;
extracting a plurality of action events corresponding to the action from the document using the machine learning model;
generating a record associated with the document based on the extracted action;
populating the record with the action parameter; and
executing an action event in the plurality of action events using the record.

2. The method of claim 1, wherein generating the record associated with the document further comprises:
mapping the extracted action to a template; and
generating the record based on a copy of the template.

3. The method of claim 1, wherein executing the action event includes transmitting the record to a computing device.

4. The method of claim 1, further comprising:
displaying an action tracker including the action and the action parameter extracted from the document.

5. The method of claim 4, further comprising:
updating the action tracker using a previous action and a previous action parameter extracted from a previous document.

6. The method of claim 1, further comprising:
querying a data store for information associated with the action.

7. The method of claim 6, wherein populating the record further comprises at least one of:
populating the record with queried information associated with the action; or
populating the record with additional information extracted from the document using the machine learning model.

8. A system comprising:
a memory component; and
a processing device coupled to the memory component, the processing device to perform operations comprising:
extracting an action from a document using a machine learning model, wherein the action is associated with an action parameter;
extracting a plurality of action events corresponding to the action from the document using the machine learning model;
generating a record associated with the document based on the extracted action;
populating the record with the action parameter; and
executing an action event in the plurality of action events using the record.

9. The system of claim 8, wherein generating the record associated with the document further comprises:
mapping the extracted action to a template; and
generating the record based on a copy of the template.

10. The system of claim 8, wherein executing the action event includes transmitting the record to a computing device.

11. The system of claim 8, wherein the processing device performs further operations comprising:
displaying an action tracker including the action and the action parameter extracted from the document.

12. The system of claim 11, wherein the processing device performs further operations comprising:
updating the action tracker using a previous action and a previous action parameter extracted from a previous document.

13. The system of claim 8, wherein the processing device performs further operations comprising:
querying a data store for information associated with the action.

14. The system of claim 8, wherein populating the record further comprises at least one of:
populating the record with queried information associated with the action; or
populating the record with additional information extracted from the document using the machine learning model.

15. A non-transitory computer-readable medium storing executable instructions, which when executed by a processing device, cause the processing device to perform operations comprising:
extracting an action and a trigger from a document using a machine learning model, wherein the action is associated with an action parameter;
displaying a user interface including a user-configurable arrangement of the action, the trigger, and the action parameter; and
executing an action event in a sequence of action events responsive to receiving an indication to execute the action, wherein executing the action event includes:
selecting a template based on the action,
generating a record using the template, and
populating the record with the action parameter.

16. The non-transitory computer-readable medium of claim 15, wherein receiving the indication to execute the action further comprises:
receiving a user input indicating that a trigger condition is satisfied.

17. The non-transitory computer-readable medium of claim 15, wherein receiving the indication to execute the action further comprises:
determining that a trigger condition is satisfied.

18. The non-transitory computer-readable medium of claim 15, wherein the user interface includes a previous action and a previous trigger extracted from a previous document.

19. The non-transitory computer-readable medium of claim 18 storing executable instructions, which, when executed by the processing device, cause the processing device to perform further operations comprising:
receiving a user selection to rearrange at least one of the action, the previous action, the trigger, or the previous trigger displayed on the user interface.

20. The non-transitory computer-readable medium of claim 15 storing executable instructions, which, when executed by the processing device, cause the processing device to perform further operations comprising:
overlaying a visual indicator indicating a portion of the document corresponding to the extracted action or the extracted trigger.
